(19) United States
(12) Patent Application Publication
(10) Pub. No.: US 2011/0139290 A1
(43) Pub. Date: Jun. 16, 2011

(54) DUCT SYSTEM COMPONENTRY

(76) Inventor: Graham Norman Duell, Victoria (AU)

(21) Appl. No.: 12/996,459

(22) PCT Filed: Jun. 4, 2009
(86) PCT No.: PCT/AU2009/000708

§ 371 Date: Feb. 11, 2011

(30) Foreign Application Priority Data
Jun. 6, 2008 (AU) 2008902895

(51) Int. Cl. F16L 9/22; B23P 19/04; B65D 63/00

(52) U.S. Cl. 138/155; 29/525.05; 24/265 EC; 24/265 BC

(57) ABSTRACT

A duct system component includes a hollow body, a generally tubular duct connection element that projects from the body and has an outer end. A band of integral continuous or intermittent outstanding formations extend about the tubular duct connection element at a position spaced from the outer end thereof, and from the body. The component further includes a strap apparatus retained or adapted to be retained in a closed transport condition on the connection element between the body and the band so that it cannot slip over the band. The strap apparatus is selectively adjustable from the transport condition to a loose fitting but closed condition for fitment over a duct into which the connection element is receivable, and then to a tight in-use condition in which the strap apparatus clamps the duct behind the band to retain the duct on the component.

### FIELD OF THE INVENTION

This invention relates generally to duct system componentry and as such is especially useful in the mounting and joining of flexible ducting of the kind employed in heating, ventilation and air-conditioning (HVAC) systems. In a second aspect, the invention is concerned with a clamping strap which has general application but is particularly applicable to the fitment of flexible HVAC ducts to joiners, registers and other system componentry.

### BACKGROUND OF THE INVENTION

In domestic HVAC systems, highly flexible and longitudinally compressible ducting is typically employed to convey air between the heater or cooler unit and outlet registers disbursed about the building. A range of system componentry including joiners and junctions of various configurations is employed to connect up the duct system, for example to branch large diameter primary ducts into smaller diameter secondary ducts with T, Y or double Y junctions.

The system components are typically integral mouldings that have a tapered tubular spigot portion that is pushed into the end of the duct, and rib and/or barb features over which the duct material is drawn. The almost universal practice is to then wrap adhesive duct tape over the end of the duct to maintain and seal the connection against escape of air. In installing a HVAC system, this task must typically be carried out by the HVAC tradesman in a confined and often unpleasant environment in the subfloor space or roof space of a house or other building.

Perhaps due in part to the unpleasant working environment, the connection achieved by this conventional method is often less than satisfactory and does not stand the test of time. Studies have shown that significant proportions of heating or cooling air are lost at poor joints that are an inadequate seal from the start or result from deterioration over time, often with the help of rodents and other wildlife. It is known for connections to wholly fail, sometimes without the occupier being aware for a significant period of time.

This problem of leaky HVAC systems, especially systems that are located externally to the space being airconditioned, such as under the floor or above the ceiling, has become a significant issue for governments and energy utilities in developed countries, for two distinct reasons. Air conditioning systems are generally powered by electricity and so in warmer climates of the first world, the highest electricity peak loads now occur on the hottest days, while the pressure to reduce greenhouse gas emissions means that energy utilities cannot be cavalier about high heat losses from the ducting of domestic central heating systems that employ conveyed air.

It is accordingly an object of this invention, at least in its application to flexible duct systems, to provide an improved approach to the mounting of the duct segments to other system componentry. Preferably, the improved approach will reduce losses of conditioned air.

It is not admitted that any of the information in this specification is common general knowledge, or that the person skilled in the art could reasonably be expected to have ascertained, understood, regarded it as relevant or combined it in any way at the priority date.

### SUMMARY OF THE INVENTION

In a first aspect, the invention provides a duct system component including:
a hollow body;
a generally tubular duct connection element that projects from the body and has an outer end;
a band of integral continuous or intermittent outstanding formation(s) extending about the tubular duct connection element at a position spaced from said outer end thereof, and from said body; and
strap means retained or adapted to be retained in a closed transport condition on said connection element between said body and said band so that it cannot slip over the band, which strap means is selectively adjustable from said transport condition to a loose fitting but closed condition for fitment over a duct into which said connection element is receivable, and then to a tight in-use condition in which the strap means clamps the duct behind said band to retain the duct on the component.

Preferably, the straps means is retained on the connection element in said closed transport condition.

Preferably, the strap means remains a closed loop during adjustment from the transport condition to the loose fitting but closed condition and then to the tight in-use condition.

By remaining as a closed loop, the strap means is less likely to fall away during fitment of the component to a duct.

In an embodiment, the band of integral continuous or intermittent outstanding formation(s) is a continuous shoulder upstanding at the exterior of the connection element and facing said body. This shoulder may be provided by a defined rib or by an outward formation of the connection element that includes a terminal portion of the element. Advantageously, this terminal portion may be inwardly tapered towards the end of the connection element so as to facilitate relative drawing of the duct onto the connection element to sufficiently pass said band of integral continuous or intermittent outstanding formation(s).

The strap means is conveniently a retention strap according to the second aspect of the invention.

In its second aspect, the invention provides a retention strap comprising a longitudinal flexible strip extending between a first end and a second end that bound respective first and second terminal portions of the strip, wherein the first terminal portion has a first engagement feature respectively co-operable with second and third engagement features on the second terminal portion to respectively define a loose fitting but closed condition of the strap and an in-use condition in which the strap may be clamped about a fitting, and wherein the second and third engagement features are simultaneously releasably latchable to define a transport condition of the strap.

Preferably, the first engagement feature is a female buckle, and the second and third engagement features are male buckles spaced along said strip and each co-operable with the female buckle.

Preferably, the mutually overlayed condition is achieved by latching the inner male buckle onto the female buckle while the latter is engaged with the outer male buckle.

Preferably movement from the transport condition to the loose fitting but closed condition is effected by disengaging the inner male buckle and the female buckle; and movement from the loose fitting but closed position to the in-use condition is effected by pulling on the second terminal portion to disengage the outer male buckle and the female buckle and engage the inner male buckle and the female buckle.

In a third aspect, the invention provides a method of fitting a duct to a duct system component according to the first aspect of the invention, including adjusting the strap means from its transport condition to its loose fitting but closed condition and, while an end of a duct is brought over said connection element past said band, or thereafter, placing the strap means in its loose fitting but closed condition about the duct, and then adjusting the strap means from its loose fitting but closed condition to its tight in-use condition behind said band to clamp the duct onto the connection element.

In a still further aspect, the invention extends to an assembly of a segment of flexible duct and a duct system component according to the first aspect of the invention.

In the various aspects of the invention, the duct system component of the invention may be, for example, a duct joiner, a junction with three or more of said connection elements, an intake register or an outlet register.

### BRIEF DESCRIPTION OF THE DRAWINGS

The invention will now be further described, by way of example only, with reference to the accompanying drawings, in which:

FIG. 1 is a perspective view of a duct system component in the form of a Y-junction joiner, in which one of the three connection elements is an embodiment of the first aspect of the invention;

FIG. 2 is a sectioned perspective view of the component of FIG. 1, but with the strap omitted;

FIGS. 3 and 4 are views similar to FIG. 1 but show successive steps in the fitment of a duct to the component illustrated in FIGS. 1 and 2;

FIG. 5 is a view similar to FIG. 2 but corresponding to FIG. 4; and

FIG. 6 is a detailed view of the female buckle of the strap and of a male buckle about to be engaged therein.

### DETAILED DESCRIPTION OF EMBODIMENTS OF THE INVENTION

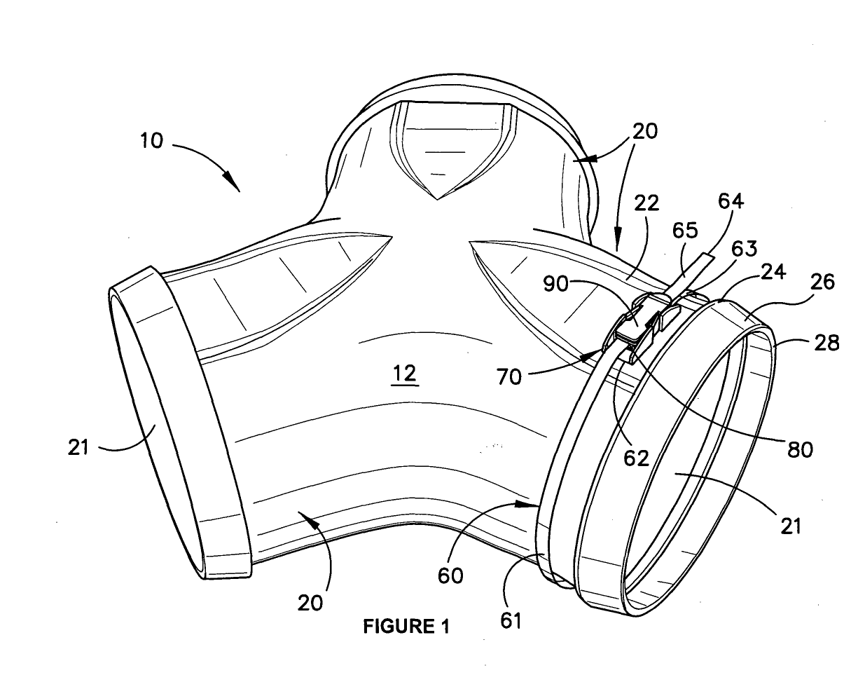

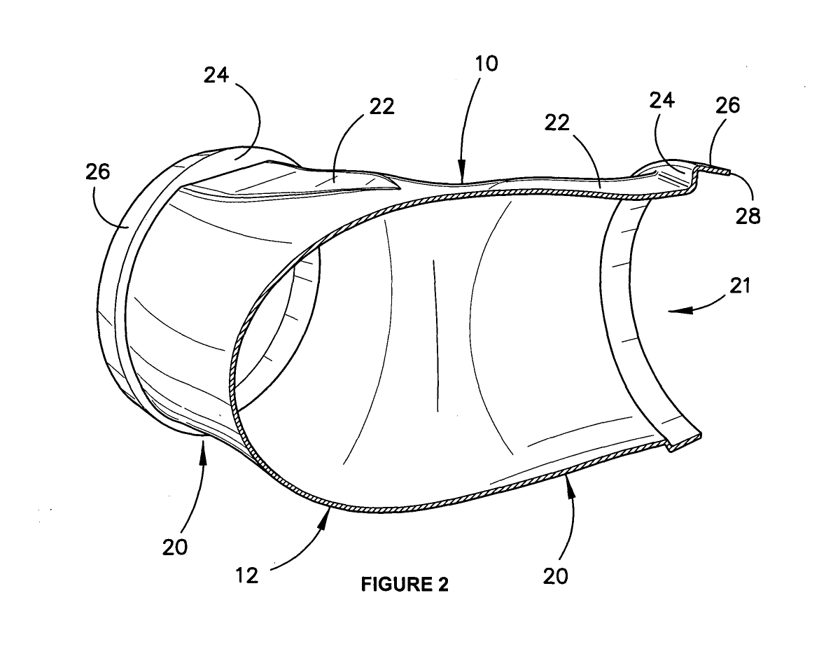

The duct system component illustrated in FIGS. 1 and 2 is a three-way or Y-junction joiner 10 for branching an HVAC air duct into two side ducts leading, for example, to different parts of a house, or to different floor outlet registers in adjacent rooms. The joiner 10 has three generally tubular connection elements 20 that in this case are of similar form and diameter but in other joiners may be of differing cross-section or diameter. For the purpose of describing this embodiment of the invention, only one of the connection elements is shown fitted with a strap 60 that is an embodiment of the second aspect of the invention and that in combination with joiner 10 provides a duct system component that is an embodiment of the first aspect of the invention. Connection elements 20 project from and are integral with a central hollow body 12 that bounds the junction between the three passages 21 defined by the connection elements 20.

Component 10 is a thin walled moulding, for example in polypropylene or polycarbonate, that is formed in each connection element 20 to provide a gently inwardly tapered inner section 22 merging into an outstanding continuous peripheral shoulder 24, and then an inwardly tapered terminal portion 26 that ends at an annular rim defining the end 28 of the connection element. It will be appreciated that shoulder 24, which faces body 12, defines a band constituting an integral continuous outstanding formation extending about the tubular duct connection element at a position spaced from both outer end 28 and body 12.

Strap 60 is retained on the connection element 20 between body 12 and shoulder 24, and is in a closed transport condition so that it cannot slip over shoulder 24: this is how the component is initially produced and delivered to end-users.

As best appreciated from comparing FIGS. 1, 3 and 4, strap 60 is a longitudinal strip 61 of high strength material, e.g., with respective first and second ends 62,64 with respective adjacent terminal portions 63,65. Terminal portion 63 has a first engagement feature in the form of a female buckle 70, while terminal portion 65 has second and third engagement features comprising an outer male buckle 80 and a similar inner male buckle 90 spaced along the strip from male buckle 80.

In the closed transport condition of the strap 60 depicted in FIG. 1, outer male buckle 80 is engaged and latched in female buckle 70, while inner male buckle 90 is latched on top of the female buckle 70 so as to overlay outer male buckle 80.

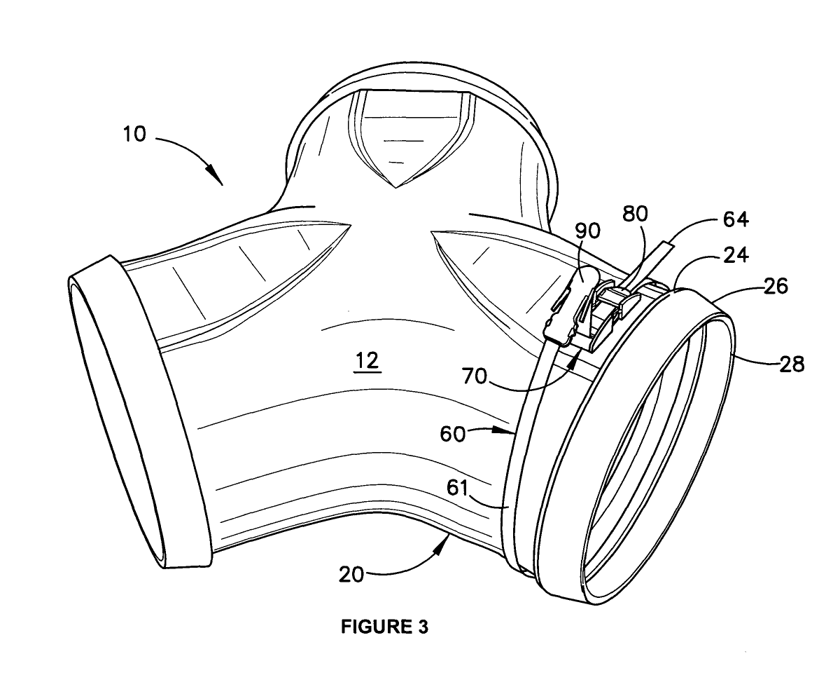

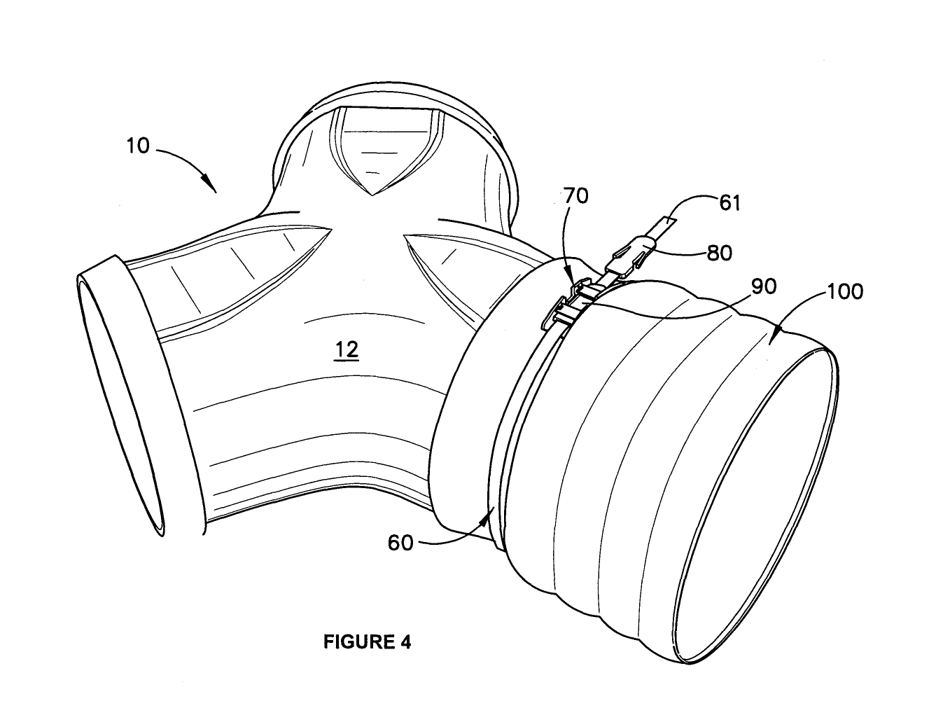

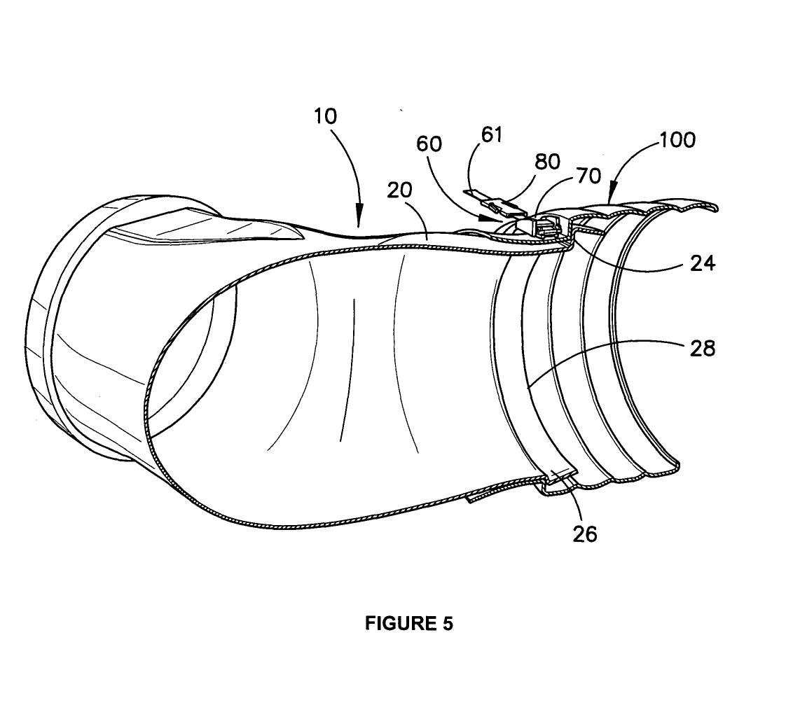

The illustrated configuration is employed in the following manner to mount a duct 100 to joiner 10. First, strap 60 is adjusted to its loose-fitting but still closed condition by unlatching inner male buckle 90 from female buckle 70, as depicted in FIG. 3. This action allows the connection portion 20 and duct 100 to be pushed together, the former into the latter, until the duct material is well past shoulder 24 and up to the body 12, as best seen in FIG. 4. During or following this action, the loosened strap 60 moves to a position outside the duct. If this position is adjusted as necessary so that the strap is just behind shoulder 24, the outer male buckle 80 can be disengaged from female buckle 70 and pulled forwardly from the female buckle. Further pulling of the male end of the strap draws inner male buckle 90 into female buckle 70 until the two snap into a latched engagement. The strap is now in its tight in-use condition in which it clamps the duct behind shoulder 24 to retain the duct on the component.

Shoulder 24 may typically be of a height from the adjacent surface of connection element 20 in the range 2 to 25 mm, most preferably 5 to 10 mm. Shoulder 24 is preferably at least partly substantially in a plane normal to the adjacent outer surface of the connection element 20.

By presetting the position of inner male buckle 90 to match the particular component and duct diameter, and if necessary allowing for the material and thickness of the duct, a firm air-sealed connection can be achieved which remains reliably positively engaged and does not require the application of any additional sealing material such as duct tape.

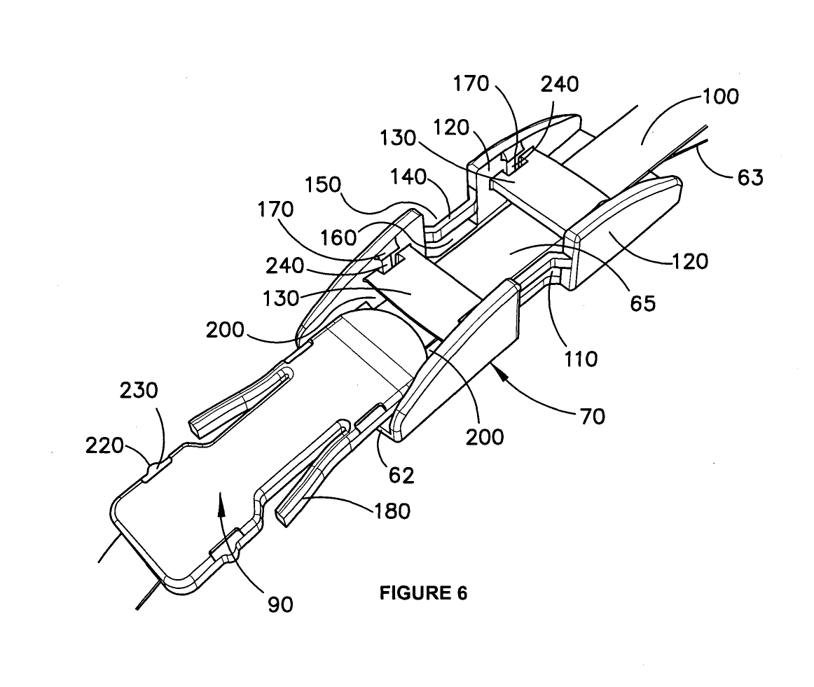

FIG. 6 illustrates part of the strap 60 in more detail. The strap 60 is illustrated intermediate its loose-fitting position and the in-use position: the inner male buckle 90 is partially received within the body of the female buckle 70.

As illustrated the female buckle 70 is of generally channel form having a floor 110 and side walls 120. Planar bridging portions 130 span the channel and interconnect the side wall portions 120. The bridging portions 130 are approximately parallel to the floor 110. The bridging portions 130 serve to vertically divide the channel into an upper and a lower region for receiving a respective male buckle. The side walls 120 have, in profile, an upper curved edge. Tangs 170 are positioned on inner faces of the walls 120 proximal the upper edge and project inwardly. A region for receiving a male buckle proportion is defined intermediate the tangs 170 and the horizontal bridging portions 130.

Cut-outs 200 through the floor 110 and through horizontal bridging portions 130 allow the female buckle 20 to be injection moulded using a simple 2-way split die. The cut-outs 200 allow a lower tool half to project upwardly through the floor 110 to form the under side of tangs 170 and horizontal bridging portions 130.

Each side wall 120 includes a central aperture spanned by a respective horizontal bridging member 140 thus defining upper and lower lateral apertures 150 and 160.

As illustrated the inner male buckle 90 includes a substantially planar main body. The body is sized for receipt in the region of female buckle 70 defined by the side walls 120, the floor 110 and the horizontal bridging portions 130. As illustrated, resiliently deformable wing portions 180 extend outwardly at a shallow angle from opposing sides of the main body. The wing portions 180 extend in a rearward direction so that as the male buckle 90 is advanced into the female buckle 70 the side walls 120 act on the wing portions 180 to press the wing portions 180 resiliently inwardly. As the male buckle is advanced through the female buckle 70 the wing portions 180 align with apertures 160 and are thus released to snap under their own bias outwardly to engage the apertures 160 and thereby prevent reversal of the buckle 90 through the female buckle 70. The male buckle 90 can be unlatched for reversal through the female buckle 70 by manually depressing the wing portions 180.

The outer male buckle 80 is omitted from FIG. 6 for clarity. The outer male buckle 80 is of identical form to the inner male buckle 90 which advantageously allows for common tooling to be used. The male buckles 80, 90 each include lands 230 and outward projections 220 for cooperating with tangs 170 and recesses 240. Recesses 240 have a profile shaped to correspond to the outward projections 220. This arrangement creates a desirable ‘solid’ feel when the buckles 80, 90 engage with the female buckle 70.

In the transport condition, outer male buckle 80 is latched in position below bridging portions 130, while inner male buckle 90 is latched above bridging portions 130 under tangs 170.

The main portion of the strap 60 is formed of a webbing type fabric which is fully flexible and relatively inextensible. This flexible construction makes handling the strap and fitting the duct easier than handling other forms of strapping that might be used, for example a standard metallic hose clip.

The above described component provides for a rapid, easy and secure sealing connection between the duct and the component. The strap is readily released from the transport position by depressing the wing portions 180 of the inner male buckle 90. After the positioning of the flexible duct 100 strap 60 is readily tightened by withdrawing strip 61 to release outer male buckle 80 until the inner male buckle 90 engages with the female buckle 70. In this in-use position the strap has a reliable and repeatable finished length such that the connection between the duct and the connector is more reliable and repeatable.

According to this embodiment, at all times at least one male buckle 80, 90 or a portion of webbing intermediate the male buckles is engaged with the female buckle 70 (unless, of course, someone were to intentionally disengage, and reverse, the outer male buckle from the female buckle 70). This engagement prevents the retention strap from opening during adjustment between the transport, loose fitting and in-use conditions. The risk of the strap 60 falling away during installation is thereby reduced.

The buckle components 70,80,90 may advantageously be of curved profile end to end to follow the contours, at least approximately, of the connection element and duct.

It will be appreciated that the illustrated structures can be varied in a variety of other ways. For example, the shoulder 24 comprises a continuous outstanding formation extending about the tubular duct connection element 20, but may be substituted by a band of intermittent outstanding formations. There may be multiple shoulders, ribs or bands or formations, as is known in the art. The first aspect of the invention need not employ the particular strap construction of the second aspect of the invention: any strap arrangement having the three conditions may be employed. The joiner 10 may be partially or wholly wrapped in insulation, as is known in the art: the insulation might, for example, be sprayed or otherwise coated on, or may be provided as a separate layer retained by adhesive.

The illustrated arrangements may be employed with conventional flexible ducting but are especially suitable for use with ducting of the kinds disclosed in Australian patent 773565, and in Australian patent applications 2005238551 and 2007907095.

1. A duct system component comprising:
a hollow body;
a generally tubular duct connection element that projects from the body and has an outer end;
a band of integral continuous or intermittent outstanding formation(s) extending about the tubular duct connection element at a position spaced from said outer end thereof, and from said body; and
strap means retained or adapted to be retained in a closed transport condition on said connection element between said body and said band so that it cannot slip over the band, which strap means is selectively adjustable from said transport condition to a loose fitting but closed condition for fitment over a duct into which said connection element is received, and then to a tight in-use condition in which the strap means clamps the duct behind said band to retain the duct on the component.

2. The duct system component of claim 1, wherein the strap means is retained on the connection element in said closed transport condition.

3. The duct system component of claim 1, wherein the strap means remains a closed loop during adjustment from the transport condition to the loose fitting but closed condition and then to the tight in-use condition.

4. The duct system component of claim 1, wherein the band of integral continuous or intermittent outstanding formation(s) is a continuous shoulder upstanding at the exterior of the connection element and facing said body.

5. The duct system component of claim 1, wherein the strap means is a retention strap comprising a longitudinal flexible strip extending between a first end and a second end that bound respective first and second terminal portions of the strip, wherein the first terminal portion has a first engagement feature respectively co-operable with second and third engagement features on the second terminal portion to respectively define the loose fitting but closed condition of the strap and the tight in-use condition, and wherein the second and third engagement features are simultaneously releasably latchable to define the transport condition.

6. The duct system component of claim 5, wherein in the transport condition the second and third engagement features are latched in a mutually overlayed condition.

7. The duct system component of claim 5, wherein the first engagement feature is a female buckle, and the second and third engagement features are male buckles spaced along said strip and each co-operable with the female buckle.

8. The duct system component strap of claim 6 wherein the first engagement feature is a female buckle, and the second and third engagement features are male buckles spaced along said strip and each co-operable with the female buckle, and wherein the mutually overlayed condition is achieved by latching the inner male buckle onto the female buckle while the latter is engaged with the outer male buckle.

9. An assembly of a segment of flexible duct and a duct system component according to claim 1.

10. A method of fitting a duct to a duct system component according to claim 1, including adjusting the strap means from its transport condition to its loose fitting but closed condition and, while an end of a duct is brought over said connection element past said band, or thereafter, placing the strap means in its loose fitting but closed condition about the duct, and then adjusting the strap means from its loose fitting but closed condition to its tight in-use condition behind said band to clamp the duct onto the connection element.

11. A retention strap comprising: a longitudinal flexible strip extending between a first end and a second end that bound respective first and second terminal portions of the strip, wherein the first terminal portion has a first engagement feature respectively co-operable with second and third engagement features on the second terminal portion to respectively define a loose fitting but closed condition of the strap and an in-use condition in which the strap may be clamped about a fitting, and wherein the second and third engagement features are simultaneously relesably latchable to define a transport condition of the strap.

12. The retention strap of claim 11, wherein in the transport condition the second and third engagement features are latched in a mutually overlayed condition.

13. The retention strap of claim 11 configured to remain in a closed loop during adjustment from the transport condition to the loose fitting but closed condition and then to the in-use condition.

14. The retention strap of claim 11, wherein the first engagement feature is a female buckle, and the second and third engagement features are male buckles spaced along said strip and each co-operable with the female buckle.

15. The retention strap of claim 12, wherein the first engagement feature is a female buckle, and the second and third engagement features are male buckles spaced along said strip and each co-operable with the female buckle, and wherein the mutually overlayed condition is achieved by latching the inner male buckle onto the female buckle while the latter is engaged with the outer male buckle.

16. The retention strap of claim 14 wherein movement from the transport condition to the loose fitting but closed condition is effected by disengaging the inner male buckle and the female buckle; and
movement from the loose fitting but closed position to the in-use condition is effected by pulling on the second terminal portion to disengage the outer male buckle and the female buckle and engage the inner male buckle and the female buckle.

17. The retention strap of claim 15 wherein movement from the transport condition to the loose fitting but closed condition is effected by disengaging the inner male buckle and the female buckle; and movement from the loose fitting but closed position to the in-use condition is effected by pulling on the second terminal portion to disengage the outer male buckle and the female buckle and engage the inner male buckle and the female buckle.

18. An assembly of a segment of flexible duct and a duct system component according to claim 5.

19. An assembly of a segment of flexible duct and a duct system component according to claim 8.
